(19) United States
(12) Patent Application Publication
(10) Pub. No.: US 2006/0173387 A1
(43) Pub. Date: Aug. 3, 2006

(54) Externally enhanced ultrasonic therapy

(76) Inventors: Douglas Hansmann, Bainbridge Island, WA (US); Curtis Genstler, Snohomish, WA (US); Francisco S. Villar, Union City, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/297,979

(22) Filed: Dec. 9, 2005

Related U.S. Application Data
(60) Provisional application No. 60/635,427, filed on Dec. 10, 2004.
(60) Provisional application No. 60/635,707, filed on Dec. 13, 2004.

(51) Int. Cl. A61H 1/00

(52) U.S. Cl. 601/2; 604/22

(57) ABSTRACT

In one embodiment, a method for treating a vascular occlusion in a patient's body comprises exposing the vascular occlusion to an external ultrasonic energy field that is generated outside the patient's body. The method further comprises positioning an ultrasound radiating member in the patient's body in the vicinity of the vascular occlusion. The method further comprises exposing the vascular occlusion to an internal ultrasonic energy field that is generated by the ultrasound radiating member. The method further comprises using the ultrasound radiating member to detect a first characteristic of the external ultrasonic energy field. The method further comprises adjusting a second characteristic of the external ultrasonic energy field based on the detected first characteristic of the external ultrasonic energy field.

### CROSS-REFERENCE TO RELATED APPLICATIONS

This application claims the benefit of U.S. Provisional Patent Application 60/635,427 (filed 10 Dec. 2004; Attorney Docket EKOS.186PR) and U.S. Provisional Patent Application 60/635,707 (filed 13 Dec. 2004; Attorney Docket EKOS.186PR2). The entire disclosure of both of these priority applications is hereby incorporated by reference herein. This application is related to U.S. patent application Ser. No. 11/272,022 (filed 11 Nov. 2005; Attorney Docket EKOS.183A), the entire disclosure of which is hereby incorporated by reference herein.

### FIELD OF THE INVENTION

The present invention relates generally to therapies that use ultrasonic energy, and relates more specifically to therapies that use an extracorporeal ultrasonic radiating member to deliver ultrasonic energy to a patient.

### BACKGROUND OF THE INVENTION

Human blood vessels occasionally become occluded by clots, plaque, thrombi, emboli or other substances that reduce the blood carrying capacity of the vessel. Cells that rely on blood passing through the occluded vessel for nourishment are endangered if the vessel remains occluded. This often results in grave consequences for a patient, particularly in the case of cells such as brain cells or heart cells.

Accordingly, several techniques have been developed for treating an occluded blood vessel. Examples of such techniques include the introduction into the vasculature of therapeutic compounds—such as enzymes, dissolution compounds and light activated drugs—that dissolve blood clots. When such therapeutic compounds are introduced into the bloodstream, systematic effects often result, rather than local effects. Accordingly, recently catheters have been used to introduce therapeutic compounds at or near the occlusion. Mechanical techniques have also been used to remove an occlusion from a blood vessel. For example, ultrasound catheters have been developed that include an ultrasound radiating member that is positioned in or near the occlusion. Ultrasonic energy is then used to ablate the occlusion. Other examples of mechanical devices include “clot grabbers” are “clot capture devices”, as disclosed in U.S. Pat. No. 5,895,398 and U.S. Pat. No. 6,652,536, which are used to withdraw a blockage into a catheter. Other techniques involve the use of lasers and mechanical thrombectomy and/or clot macerator devices.

One particularly effective apparatus and method for removing an occlusion uses the combination of ultrasonic energy and a therapeutic compound that removes an occlusion. Using such systems, a blockage is removed by advancing an ultrasound catheter through the patient's vasculature that is also capable of delivering therapeutic compounds directly to the blockage site. To enhance the therapeutic effects of the therapeutic compound, ultrasonic energy is emitted into the therapeutic compound and/or the surrounding tissue. See, for example, U.S. Pat. No. 6,001,069 and U.S. Patent Application Publication 2005/0215942.

### BRIEF SUMMARY OF THE INVENTION

While simultaneous intravascular delivery of therapeutic compounds and ultrasonic energy provides certain advantages, limitations to this treatment methodology do exist. For example, the intensity of ultrasonic energy generated by a catheter-based ultrasound radiating member is limited by a number of factors. For instance, the temperature generated at the treatment site should not exceed the threshold at which tissue damage occurs. Also, the ultrasound radiating member receives electrical power from elongate conductors deployed within the catheter body; the current-carrying capacity of these conductors has some finite limit. Because the intensity of the ultrasonic energy field is limited, the spatial extent of the treatment region is likewise limited. Moreover, the physical size and flexibility of the catheter limit how far into the patient's vasculature the catheter can be placed without damaging the vessel. Additionally, because use of an intravascular catheter involves a surgical procedure, it is difficult to begin treatment quickly, such as at the onset of a stroke. Therefore, in certain respects catheter-based treatments are less useful and less versatile in the treatment of vascular occlusions in certain applications, and particularly with respect to small vessel applications.

In view of the foregoing limitations, Applicants have developed improved systems and methods for treating vascular occlusions. In certain embodiments, ultrasonic energy generated by an extracorporeal ultrasound radiating member is used to treat vascular occlusions. The externally generated ultrasonic energy is optionally used to enhance the effect of therapeutic compounds delivered either locally or systemically. The externally generated ultrasonic energy is also optionally used to enhance and/or supplement ultrasonic energy generated intravascularly.

In one embodiment of the present invention, a method for treating a vascular occlusion in a patient's body comprises exposing the vascular occlusion to an external ultrasonic energy field that is generated outside the patient's body. The method further comprises positioning an ultrasound radiating member in the patient's body in the vicinity of the vascular occlusion. The method further comprises exposing the vascular occlusion to an internal ultrasonic energy field that is generated by the ultrasound radiating member. The method further comprises using the ultrasound radiating member to detect a first characteristic of the external ultrasonic energy field. The method further comprises adjusting a second characteristic of the external ultrasonic energy field based on the detected first characteristic of the external ultrasonic energy field.

In another embodiment of the present invention, a system for treating a vascular occlusion within a patient's vasculature comprises an extracorporeal ultrasound radiating member positioned within a housing. The system further comprises an internal ultrasound radiating member coupled to an elongate body that is configured to be passed through the patient's vasculature to the vascular occlusion. The system further comprises a control system that is configured to (a) supply an extracorporeal drive signal to the extracorporeal ultrasound radiating member and an internal drive signal to the internal ultrasound radiating member; and (b) receive a microphone signal from the internal ultrasound radiating member. The control system is configured to adjust the extracorporeal drive signal based on the microphone signal.

In another embodiment of the present invention, a method comprises positioning an ultrasound radiating member in a patient's vasculature in the vicinity of a vascular occlusion. The method further comprises irradiating the vascular occlusion with ultrasonic energy generated by a first ultrasonic energy field that is generated by the ultrasound radiating member. The method further comprises delivering a therapeutic compound to the vascular occlusion. The method further comprises exposing a portion of the patient's vasculature that is downstream with respect to the vascular occlusion to a second ultrasonic energy field that is generated by an extracorporeal ultrasound radiating member.

### BRIEF DESCRIPTION OF THE DRAWINGS

Exemplary embodiments of the ultrasound-based treatment systems and methods are illustrated in the accompanying drawings, which are for illustrative purposes only. The drawings comprise the following figures, in which like numerals indicate like parts.

FIG. 1 is a schematic illustration of selected components of an example system capable of treating vascular occlusions with ultrasonic energy.

FIG. 2 is a schematic illustration of an example method of using the system of FIG. 1 in the treatment of an occlusion of the cerebral vasculature.

FIG. 3 is a schematic illustration of an example method of using the system of FIG. 1 in the treatment of an occlusion of the peripheral vasculature.

FIG. 4 is a flowchart illustrating an example process for using an internal transducer as a microphone to manipulate an externally-generated ultrasonic energy field in the treatment of a vascular occlusion.

FIG. 5A is a cross-sectional view of a distal end of an ultrasound catheter particularly well suited for use within small vessels of the distal anatomy.

FIG. 5B is a cross-sectional view of the ultrasound catheter of FIG. 5 taken through line 5B-5B.

### DETAILED DESCRIPTION OF THE INVENTION

Introduction.

Disclosed herein are systems and methods for treating vascular occlusions with ultrasonic energy generated by an extracorporeal ultrasound radiating member. Such treatments are optionally combined with (a) local or systemic delivery of a therapeutic compound; and/or (b) intravascular generation of ultrasonic energy. For example, in one specific application a thrombotic occlusion of a cerebral vascular artery is treated with local delivery of a clot dissolving agent, such as tissue plasminogen activator, and external delivery of ultrasonic energy. In other embodiments, other portions of the anatomy are treated.

Conventionally, externally generated ultrasonic energy used in the treatment of a vascular occlusion falls within either a low frequency spectrum (typically between about 40 kHz and about 200 kHz) or a high frequency spectrum (typically greater than about 2 MHz). Ultrasonic energy in the low frequency spectrum is advantageously able to penetrate relatively far into the patient's anatomy, but is disadvantageously unable to be narrowly focused, thus resulting in irradiation of a relatively large portion of the patient's anatomy. Ultrasonic energy in the high frequency spectrum is advantageously able to be more narrowly focused toward specific anatomical regions to be treated, but disadvantageously has less efficient transmissivity through the patient's anatomy, and thus is often limited to use through specific anatomic “windows”, such as the temple above and in front of the ears.

There are certain disadvantages with the conventional uses of externally generated ultrasonic energy set forth herein. For example, use of low frequency externally generated ultrasonic energy has been shown to produce high rates of intracranial hemorrhage in stroke victims. Because the low frequency ultrasonic energy is unfocussed, the entire irradiated portion of the patient's anatomy is susceptible to this effect, which often causes clinically unacceptable risks. High frequency externally generated ultrasonic energy, which is routinely used to detect and image flowing blood using a transcranial Doppler device, is difficult to direct and image with respect to an occluded vessel which has no flowing blood. Therefore, the placement and direction of high frequency ultrasonic energy is generally a difficult process which does not lend itself to automation.

Terminology.

As used herein, the terms “ultrasound energy” and “ultrasonic energy” are used broadly, include their ordinary meanings, and further include mechanical energy transferred through pressure or compression waves with a frequency greater than about 20 kHz. In one embodiment, the waves of the ultrasonic energy have a frequency between about 500 kHz and about 20 MHz, and in another embodiment the waves of ultrasonic energy have a frequency between about 1 MHz and about 3 MHz. In yet another embodiment, the waves of ultrasonic energy have a frequency of about 3 MHz.

As used herein, the term “catheter” is used broadly, includes its ordinary meaning, and further includes an elongate flexible tube configured to be inserted into the body of a patient, such as, for example, a body cavity, duct or vessel.

As used herein, the term “therapeutic compound” broadly refers, in addition to its ordinary meaning, to a drug, medicament, dissolution compound, genetic material, protein, or any other substance capable of effecting physiological functions. The therapeutic compound optionally includes microbubbles and/or is delivered within a microbubble. Additionally, a mixture comprising such substances is encompassed within this definition of “therapeutic compound”.

As used herein, the term “treatment site” is used broadly, includes its ordinary meaning, and further includes a region where a medical procedure is performed within a patient's body. Where the medical procedure is a treatment configured to reduce an occlusion within the patient's vasculature, the term “treatment site” refers to the region of the obstruction, as well as the region upstream of the obstruction and the region downstream of the obstruction.

Treatment of Vascular Occlusions.

In certain embodiments, both internally generated ultrasonic energy and externally generated ultrasonic energy are used in combination for the treatment of a vascular occlusion. By making this combination, It is possible to reduce or ameliorate the disadvantages of these approaches when taken individually. For example, in one application a combination of systemic delivery of therapeutic compound and external delivery of ultrasonic energy is applied as soon as a patient with a suspected cerebral thrombosis has been determined not to have an intracranial hemorrhage. This rapid application of treatment is particularly advantageous in such applications wherein time is of the essence to preserve brain function. However, in this same application, once treatment has been initiated using external ultrasound and systemic therapeutic compound delivery, an angiographic evaluation of the patient is performed to determine the location of the occlusion, and therefore whether the occlusion is locally treatable. If so, an ultrasound catheter is placed at the treatment site and is used to deliver therapeutic compound and/or ultrasonic energy in a way that is synergistic with the externally generated ultrasonic energy and the systemically delivered therapeutic compound.

In one embodiment, once an ultrasound catheter is positioned at the occlusion site, the external ultrasound radiating member is moved over portions of the vasculature that are distal to the occlusion. This allows the portions of the vasculature distal to the occlusion to be subjected to both the externally-generated ultrasonic energy and the therapeutic compound infused from the catheter. This would not be possible if either the external or internal approaches were used alone. Specifically, the internal, catheter-based approach is generally unable to provide ultrasonic energy to portions of the vasculature that are not adjacent to the catheter. The external treatment approach is generally unable to provide therapeutic compound to the distal portions of the vasculature because many therapeutic compounds have a short half life that makes systemic delivery to remote portions of the patient's vasculature inefficient or impractical. Therefore, combining the external and internal treatment approaches advantageously provides concentrated local therapy to clear the primary occlusion while also providing accelerated global lysis for multiple occlusion sites or for distal occlusions. In some cases, distal occlusions exist independently from the primary occlusion, while in other cases distal occlusions result from emboli shed from dissolving the primary occlusion.

An ultrasound radiating member coupled to an ultrasound catheter, or a guidewire used with a catheter, is capable of receiving ultrasonic energy as well as generating ultrasonic energy. Thus, the internal ultrasound radiating member in an ultrasound catheter is usable as a microphone to detect the extent to which it is exposed to externally generated ultrasonic energy, if at all. In particular, as the position and orientation of the externally generated ultrasonic energy field is adjusted, the signal generated by the internal ultrasound radiating member is monitored and analyzed. Therefore, in certain embodiments the internal ultrasound radiating member is used to aid in the orientation and/or positioning of the externally generated ultrasonic energy field. This helps an operator to orient the externally generated ultrasonic energy field in a way that improves treatment of a primary occlusion where the ultrasound catheter has been positioned, or that improves ultrasound exposure to other locations of the vasculature, for example to treat other occlusions. In yet another embodiment, an ultrasound catheter having a plurality of transducers is used to perform mathematical triangulation and further adjust the position and orientation of the externally-generated ultrasonic energy field with greater accuracy.

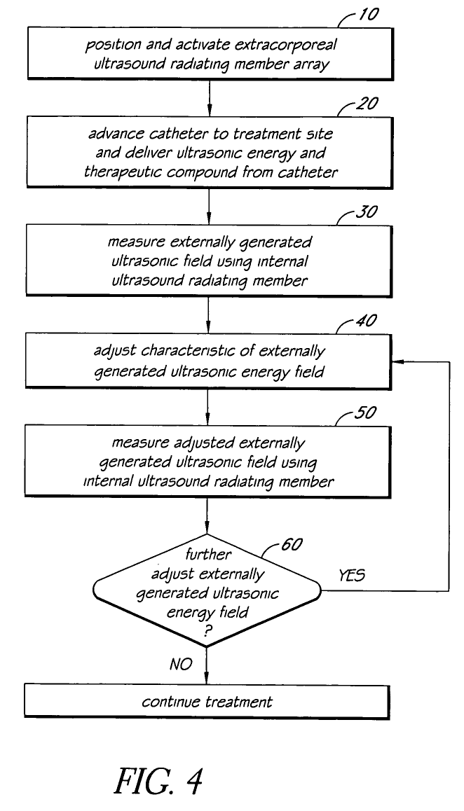

An example process for using an internal transducer as a microphone to manipulate an externally-generated ultrasonic energy field in the treatment of a vascular occlusion is illustrated in the flowchart of FIG. 4. In this example, treatment is initiated using the externally-generated ultrasonic array, as indicated by operational block 10. Then internal treatment is initiated by advancing an ultrasound catheter to the treatment site and delivering ultrasonic energy to the vascular occlusion, as indicated by operational block 20. The ultrasonic energy is delivered from an ultrasound radiating member positioned in the vicinity of the vascular occlusion. As used in this context, an ultrasound radiating member “in the vicinity of” a vascular occlusion is capable of delivering a therapeutically effective amount of ultrasonic energy to the occlusion. In certain embodiments, the ultrasound radiating member is positioned within the occlusion. Regardless of the exact position of the ultrasound radiating member, this arrangement advantageously allows the treatment to be initiated quickly using the extracorporeal ultrasonic energy field, which can be in use during delivery of the ultrasound catheter to the treatment site.

Once the ultrasound catheter is positioned at the treatment site, the magnitude of the externally-generated ultrasonic energy field is measured using an ultrasound radiating member positioned at the treatment site as a microphone, as indicated by operational block 30. The position and/or orientation of the extracorporeal ultrasound radiating member array is adjusted, as indicated by operational block 40. The magnitude of the externally-generated ultrasonic energy field is measured at the treatment site again, as indicated by operational block 50. The externally-generated ultrasonic energy field is optionally adjusted further, as indicated by operational block 60. In an example embodiment, further adjustments are made based on how an earlier adjustment affected the magnitude of the ultrasonic energy field at the treatment site.

Just as one or more internal ultrasound radiating members are usable to detect the position and orientation of the externally generated ultrasonic energy field, one or more external ultrasound radiating members are usable to detect the presence and intensity of an internally generated ultrasonic energy field. Therefore, in certain embodiments similar location and intensity monitoring functions are performed using signals sensed with an extracorporeal ultrasound radiating member. In other embodiments, a combination of these approaches is used, wherein both internally and externally positioned ultrasound radiating members are used as microphones as well as sources of ultrasonic energy.

In a modified embodiment, the ultrasound catheter includes one or more ultrasound radiating members that are used as microphones only, and that are not used to deliver ultrasonic energy. Optionally, the ultrasound catheter does not include a ultrasound radiating member used to deliver ultrasonic energy. This configuration advantageously allows the ultrasound catheter to be provided with especially small dimensions, thereby enabling the delivery of a therapeutic compound to an especially small vessel, where the ultrasonic energy is provided using an extracorporeal ultrasound radiating member only. Such embodiments are particularly advantageous in embodiments wherein an ultrasound catheter with a larger ultrasound radiating member would not be able to be safely passed to the treatment site.

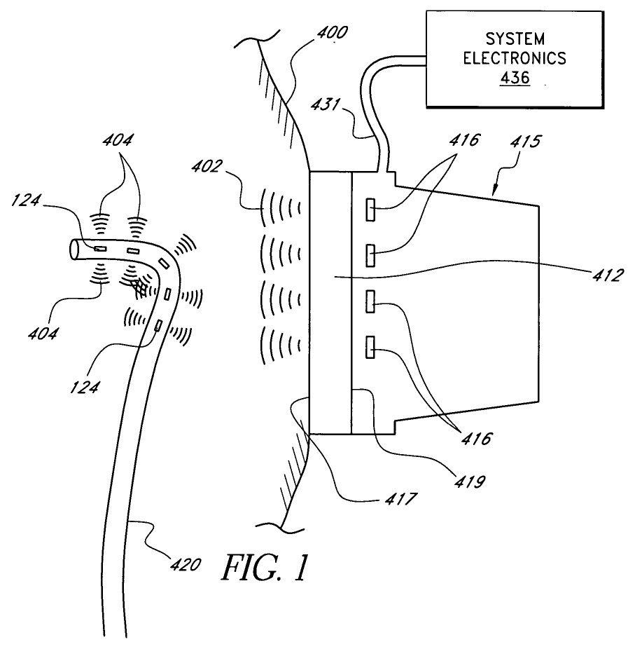

FIG. 1 illustrates selected components of an example system that is usable in accordance with certain of the embodiments disclosed herein. The system includes a housing 415 configured to hold one or more extracorporeal ultrasound radiating members 416 adjacent to a patient's body 400. The housing 415 is optionally configured to hold other components, such as control circuitry, a power converter, or a battery, associated with the extracorporeal ultrasound radiating members 416. In the illustrated embodiment, system electronics, also referred to herein as control circuitry 436, are positioned remotely from the housing 415, and is connected to the housing 415 by cable 431. The control circuitry 436 optionally includes a user interface.

The ultrasound radiating members 416 are positioned within the housing so as to be able to (a) irradiate a portion of the patient's body 400 with an externally generated ultrasonic energy field 402, and (b) receive ultrasonic energy generated from an internal ultrasound radiating member. An optional interface 412 is positioned between the housing 415 and the patient's body 400 to enhance coupling of ultrasonic energy between the patient's body 400 and the ultrasound radiating members 416. In the illustrated example embodiment, the interface 412 is positioned directly against a coupling surface 419 of the housing 415, and a skin surface 417 of the patient's body 400.

Still referring to FIG. 1, the example system further comprises a catheter 420 that includes one or more internal ultrasound radiating members 124. While the catheter 420 illustrated in FIG. 1 includes five ultrasound radiating members 124, more or fewer ultrasound radiating members are used in other embodiments. Optionally, the ultrasound radiating members 124 are movable within the catheter 420 by manipulating a controller at a proximal end of the catheter 420. As described herein the internal ultrasound radiating members 124 are configured to (a) irradiate a portion of the patient's vasculature with a locally generated ultrasonic energy field 404, and (b) receive ultrasonic energy generated from the extracorporeal ultrasound radiating members 416. The catheter 420 is preferably positioned within the patient's body 400, more preferably positioned within the patient's vascular system, and most preferably positioned at a vascular occlusion. The catheter 420 is optionally coupled to the control circuitry 436, which is used to control both the internal and the external ultrasound radiating members in such embodiments.

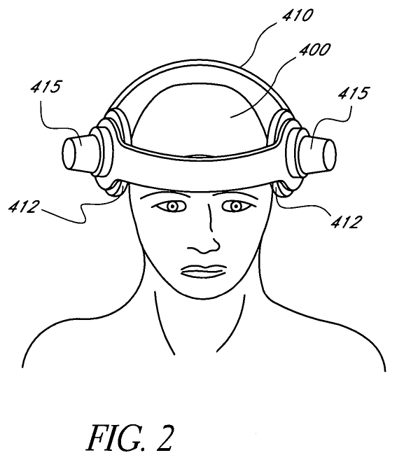

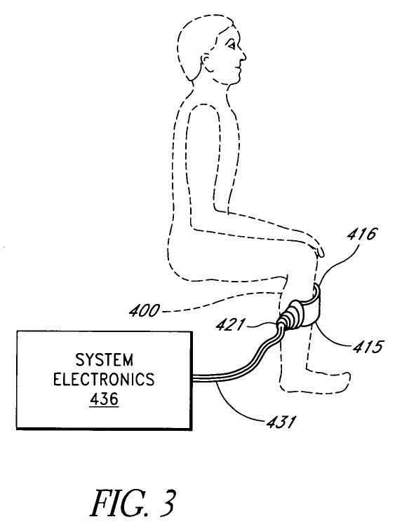

The system illustrated in FIG. 1 is usable to treat vascular occlusions at a wide variety of locations within the patient's vasculature. For example, FIG. 2 illustrates an example application wherein the system is used to treat an occlusion in the cerebral vasculature. In such embodiments, the ultrasound radiating member housing 415 is mounted to a headset 410 that is configured to be secured to the patient's body 400. As illustrated, more than one ultrasound radiating member housing 415 is coupled to the headset 410 in certain embodiments. FIG. 3 illustrates another example application wherein the system is used to treat an occlusion in the peripheral vasculature. In such embodiments, the shape of the housing 415 is modified or is modifiable to conform to the portion of the body 400 to be treated. In the illustrated embodiment, ultrasound radiating member arrays 416, 421 are positioned on opposite sides of the appendage to be treated, although in other embodiments more than or fewer than two ultrasound radiating member arrays are used. The control circuitry 436 is positioned remotely from the housing 415, and is connected to the housing 415 by cable 431, although in other embodiments the control circuitry is coupled directly to the housing 415.

In certain embodiments, the information provided from an ultrasound radiating member operating as a microphone is used by an operator to manually adjust certain characteristics of an ultrasonic energy field. In a modified embodiment, the information provided from an ultrasound radiating member operating as a microphone is used to automatically adjust certain characteristics of an ultrasonic energy field. Examples of such characteristics subject to adjustment based on information detected by a microphone include field intensity, field position, field orientation, ultrasound frequency, pulse width and pulse shape. Optionally, one or more supplementary sensors are included on the catheter and/or the guidewire to provide additional information to an operator or an automated feedback system. Examples of such supplementary sensors include, but are not limited to, temperature sensors, pH sensors, blood chemistry sensors, drug concentration sensors, and flow rate sensors. For example, in one embodiment temperature measurements are used to evaluate the position of an occlusion relative to the catheter, and/or the extent of blood flow reestablishment. Additional information regarding this application are provided in U.S. Patent Application Publication 2005/0215946, the entirety of which is hereby incorporated by reference herein.

An externally detected feedback signal that is produced by an ultrasound catheter and/or a guidewire, and that is used for positioning or other control, takes a wide variety of different forms. For example, in certain embodiments the catheter is configured to produce an externally deterred ultrasonic signal or radiofrequency signal. In other embodiments, the ultrasonic energy generated by the catheter is frequency- or amplitude-modulated, thereby enabling an external sensor to detect and analyze the modulated signal.

The techniques disclosed herein are usable with a wide variety of different catheter configurations. For example, U.S. Patent Application Publication 2004/0024347 discloses embodiments of an ultrasound catheter particularly well suited for treatment of vascular occlusions in the peripheral anatomy, such as the leg; the entire disclosure of this publication is hereby incorporated by reference herein. Likewise, U.S. Patent Application Publication 2004/0068189 and U.S. Patent Application Publication 2005/0215942 disclose embodiments of an ultrasound catheter particularly well suited for treatment of vascular occlusions in the small vessel anatomy, such as in the brain; the entire disclosure of both of these publications are hereby incorporated by reference herein.

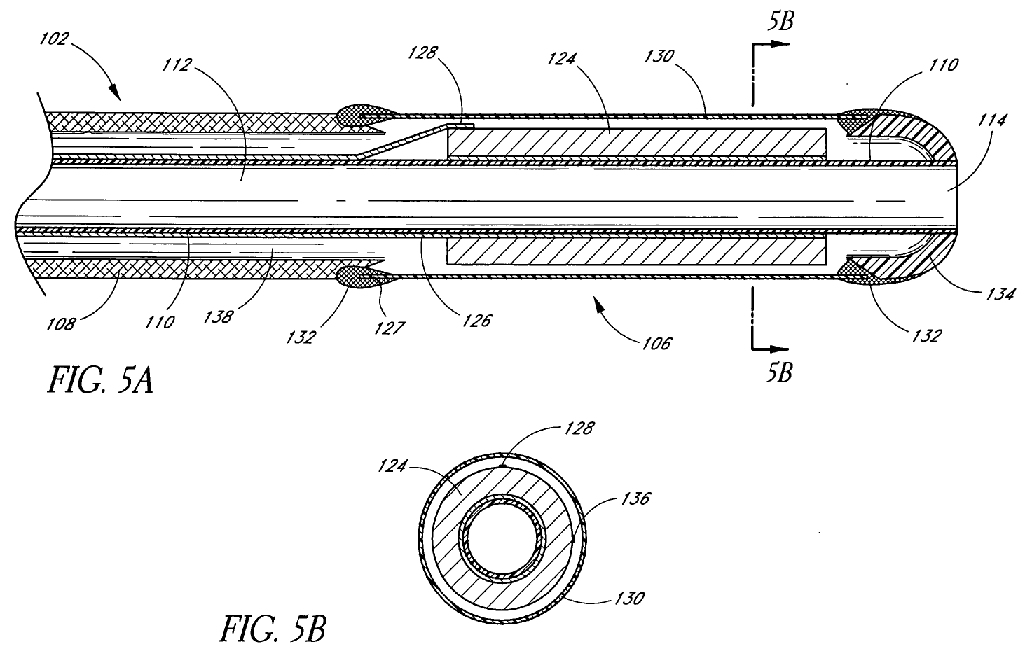

For example, FIGS. 5A and 5B illustrate an exemplary embodiment of an ultrasound catheter that is particularly well suited for use within small vessels of the distal anatomy, such as the remote, small diameter blood vessels located in the brain. The ultrasound catheter generally comprises a multi-component tubular body 102 having a proximal end (not shown) and a distal end 106. Suitable materials and dimensions are selected based on the natural and anatomical dimensions of the treatment site and of the desired percutaneous access site In an example embodiment, the ultrasound catheter has sufficient structural integrity, or “pushability,” to permit the catheter to be advanced through a patient's vasculature to a treatment site without significant buckling or kinking. In addition, the catheter can transmit torque (that is, the catheter has “torqueability”), thereby allowing the distal portion of the catheter to be rotated into a desired orientation by applying a torque to the proximal end.

In an example embodiment, the elongate flexible tubular body 102 comprises an outer sheath 108 positioned upon an inner core 110. In one embodiment, the outer sheath 108 comprises a material such as extruded Pebax®, polytetrafluoroethylene (“PTFE”), PEEK, PE, polyimides, braided polyimides and/or other similar materials. The distal end portion of the outer sheath 108 is adapted for advancement through vessels having a small diameter, such as found in the brain. In an example embodiment, the distal end portion of the outer sheath 108 has an outer diameter between about 2 French and about 6 French. In an example embodiment, the outer sheath 108 has an axial length of approximately 150 centimeters. In other embodiments, other dimensions are used.

Still referring to FIGS. 5A and 5B, the inner core 110 at least partially defines a delivery lumen 112. In an example embodiment, the delivery lumen 112 extends longitudinally along substantially the entire length of the catheter. The delivery lumen 112 comprises a distal exit port 114 and a proximal access port usable to supply a fluid to the delivery lumen, such as a cooling fluid or a therapeutic compound.

In an exemplary embodiment, the delivery lumen 112 is configured to receive a guidewire (not shown). In one embodiment, the guidewire has a diameter of approximately 0.008 inches to approximately 0.018 inches. In another embodiment, the guidewire has a diameter of about 0.010 inches. In another embodiment, the guidewire has a diameter of about 0.016 inches. In an example embodiment, the inner core 110 comprises polyimide or a similar material which, in some embodiments, is optionally braided and/or coiled to increase the flexibility of the tubular body 102.

The distal end 106 of the tubular body 102 comprises an ultrasound radiating member 124, such as an ultrasound transducer that converts electrical energy into ultrasonic energy. In a modified embodiment, the ultrasonic energy is generated by an ultrasound transducer that is remote from the ultrasound radiating element 124, and the ultrasonic energy is transmitted via, for example, a wire to the ultrasound radiating member 124.

In the example embodiment illustrated in FIGS. 5A and 5B, the ultrasound radiating member 124 is configured as a hollow cylinder. As such, the inner core 110 extends through the hollow core of the ultrasound radiating member 124. The ultrasound radiating member 124 is secured to the inner core 110 with an adhesive, although other techniques for securing the ultrasound radiating member 124 are used in other embodiments. A potting material is optionally used to further secure the ultrasound radiating member 124 to the central core.

In other embodiments, the ultrasound radiating member 124 has different shape. For example, in other embodiments the ultrasound radiating member 124 is shaped as a solid rod, a disk, a solid rectangle or a thin block. In still other embodiments, the ultrasound radiating member 124 comprises a plurality of smaller ultrasound radiating elements. The embodiments illustrated in FIGS. 5A and 5B advantageously provide enhanced cooling of the ultrasound radiating member 124. For example, in an exemplary embodiment, a therapeutic compound is delivered through the delivery lumen 112. As the therapeutic compound passes through the lumen of the ultrasound radiating member 124, the therapeutic compound advantageously removes heat generated by the ultrasound radiating member 124. In another embodiment, a return fluid path is formed in region 138 between the outer sheath 108 and the inner core 110, such that coolant from a coolant system is directed through region 138.

In an example embodiment, the ultrasound radiating member 124 is selected to produce ultrasonic energy in a frequency range adapted for a particular application. Suitable frequencies of ultrasonic energy for the applications described herein include, but are not limited to, from about 20 kHz to about 20 MHz. In one embodiment, the frequency is between about 500 kHz and about 20 MHz, and in another embodiment, the frequency is between about 1 MHz and about 3 MHz. In yet another embodiment, the ultrasonic energy has a frequency of about 3 MHz. For example, in one embodiment, the dimensions of the ultrasound radiating member 124 are selected to provide a ultrasound radiating member that is capable of generating sufficient acoustic energy to enhance lysis without significantly adversely affecting catheter maneuverability.

As described above, in the embodiment illustrated in FIGS. 5A and 5B ultrasonic energy is generated from electrical power supplied to the ultrasound radiating member 124. The electrical power is supplied through control circuitry, which is connected to conductive wires 126, 128 that extend through the tubular body 102. The conductive wires 126, 128 are optionally secured to the inner core 110, laid along the inner core 110, and/or extended freely in the region 138 between the inner core 110 and the outer sheath 108. In the illustrated embodiments, the first wire 126 is connected to the hollow center of the ultrasound radiating member 124, while the second wire 128 is connected to the outer periphery of the ultrasound radiating member 124. In an example embodiment, the ultrasound radiating member 124 comprises a transducer formed of a piezoelectric ceramic oscillator or a similar material.

In the exemplary embodiment illustrated in FIGS. 5A and 5B, the distal end 106 of the catheter includes a sleeve 130 that is generally positioned about the ultrasound radiating member 124. In such embodiments, the sleeve 130 comprises a material that readily transmits ultrasonic energy. Suitable materials for the sleeve 130 include, but are not limited to, polyolefins, polyimides, polyesters and other materials that readily transmit ultrasonic energy with minimal absorption of the ultrasonic energy. The proximal end of the sleeve 130 is optionally attached to the outer sheath 108 with an adhesive 132. In certain embodiments, to improve the bonding of the adhesive 132 to the outer sheath 108, a shoulder 127 or notch is formed in the outer sheath 108 for attachment of the adhesive 132 thereto. In an exemplary embodiment, the outer sheath 108 and the sleeve 130 have substantially the same outer diameter. In other embodiments, the sleeve 130 can be attached to the outer sheath 108 using heat bonding techniques, such as radiofrequency welding, hot air bonding, or direct contact heat bonding. In still other embodiments, techniques such as over molding, dip coating, film casting and so forth can be used.

The distal end of the sleeve 130 is attached to a tip 134. As illustrated, the tip 134 is attached to the distal end of the inner core 110. In one embodiment, the tip is between about 0.5 millimeters and about 4.0 millimeters long. In another embodiment, the tip is about 2.0 millimeters long. As illustrated, in certain embodiments the tip is rounded in shape to reduce trauma or damage to tissue along the inner wall of a blood vessel or other body structure during advancement toward a treatment site.

The ultrasound catheter optionally includes at least one temperature sensor 136 along the distal end 106. In one embodiment, the temperature sensor 136 is positioned on or near the ultrasound radiating member 124. Suitable temperature sensors include but are not limited to, diodes, thermistors, thermocouples, resistance temperature detectors, and fiber optic temperature sensors that used thermalchromic liquid crystals. In an example embodiment, the temperature sensor 136 is operatively connected to control circuitry through a control wire that extends through the tubular body 102.

As described herein, an interface is positioned between the external transducer and the patient in certain embodiments. The interface is used as a coupling agent, and in an example embodiment comprises a gel that is optionally placed within a disposable pad. In another example embodiment, at least a portion of the external transducer and the area to be treated is immersed in water or another liquid. Additional information regarding the use of interfaces in combination with externally generated ultrasonic energy fields is provided in U.S. patent application Ser. No. 11/272,022, the entire disclosure of which is hereby incorporated by reference herein.

### SCOPE OF THE INVENTION

While the foregoing detailed description discloses several embodiments of the present invention, it should be understood that this disclosure is illustrative only and is not limiting of the present invention. It should be appreciated that the specific configurations and operations disclosed can differ from those described above, and that the methods described herein can be used in contexts other than treatment of vascular occlusions. Furthermore, the methods disclosed herein are limited to neither the exact sequence of events or acts described, nor the practice of all the events or acts disclosed. Other sequences of events or acts, or less than all of the events or acts, or simultaneous occurrence of certain events or acts are within the scope of the embodiments disclosed herein.

We claim:

1. A method for treating a vascular occlusion in a patient's body, the method comprising:
exposing the vascular occlusion to an external ultrasonic energy field that is generated outside the patient's body;
positioning an ultrasound radiating member in the patient's body in the vicinity of the vascular occlusion;
exposing the vascular occlusion to an internal ultrasonic energy field that is generated by the ultrasound radiating member;
using the ultrasound radiating member to detect a first characteristic of the external ultrasonic energy field; and
adjusting a second characteristic of the external ultrasonic energy field based on the detected first characteristic of the external ultrasonic energy field.

2. The method of claim 1, wherein the ultrasound radiating member is used to detect the first characteristic before the vascular occlusion is exposed to the internal ultrasonic energy field.

3. The method of claim 1, wherein the internal ultrasonic energy field is generated by applying a voltage difference to the ultrasound radiating member.

4. The method of claim 1, wherein the external ultrasonic energy field is generated by an array of extracorporeal ultrasound radiating members positioned within a housing.

5. The method of claim 1, wherein the ultrasound radiating member is positioned on a guidewire that is used in the delivery of a catheter to the treatment site, wherein the catheter includes a fluid delivery lumen adapted to deliver a therapeutic compound to the vascular occlusion.

6. The method of claim 1, wherein the ultrasound radiating member is positioned in the patient's body after the vascular occlusion is exposed to the external ultrasonic energy field.

7. The method of claim 1, wherein the ultrasound radiating member is positioned on a catheter that includes a fluid delivery lumen adapted to deliver a therapeutic compound to the vascular occlusion.

8. The method of claim 1, further comprising delivering a therapeutic compound from a catheter to the vascular occlusion during exposure of the vascular occlusion to at least one of the external ultrasonic energy field and the internal ultrasonic energy field.

9. The method of claim 1, wherein the first characteristic of the external ultrasonic energy field is power delivered to the vascular occlusion.

10. The method of claim 1, wherein the second characteristic of the external ultrasonic energy field is selected from the group consisting of field position, field orientation, pulse width and duty cycle.

11. A system for treating a vascular occlusion within a patient's vasculature, the system comprising:
an extracorporeal ultrasound radiating member positioned within a housing;
an internal ultrasound radiating member coupled to an elongate body that is configured to be passed through the patient's vasculature to the vascular occlusion; and
a control system that is configured to (a) supply an extracorporeal drive signal to the extracorporeal ultrasound radiating member and an internal drive signal to the internal ultrasound radiating member, and (b) receive a microphone signal from the internal ultrasound radiating member, wherein the control system is configured to adjust the extracorporeal drive signal based on the microphone signal.

12. The system of claim 11, wherein the elongate body is selected from the group consisting of a guidewire and a catheter body.

13. The system of claim 11, wherein the elongate body is a catheter having a fluid delivery lumen configured to deliver a therapeutic compound to the vascular occlusion.

14. The system of claim 11, further comprising an interface configured to be coupled to the housing, wherein the interface comprises an acoustically transmissive material.

15. The system of claim 11, wherein a plurality of extracorporeal ultrasound radiating members are positioned within the housing.

16. The system of claim 11, further comprising a user interface configured to display information related to the microphone signal.

17. The system of claim 11, further comprising a temperature sensor coupled to the elongate body, wherein the temperature sensor is configured to provide a temperature signal to the control system.

18. A method comprising:
positioning an ultrasound radiating member in a patient's vasculature in the vicinity of a vascular occlusion;
irradiating the vascular occlusion with ultrasonic energy generated by a first ultrasonic energy field that is generated by the ultrasound radiating member;
delivering a therapeutic compound to the vascular occlusion; and
exposing a portion of the patient's vasculature that is downstream with respect to the vascular occlusion to a second ultrasonic energy field that is generated by an extracorporeal ultrasound radiating member.

19. The method of claim 18, wherein the ultrasound radiating member comprises a piezoelectric element.

20. The method of claim 18, wherein the ultrasound radiating member is coupled to a catheter that includes a fluid delivery lumen that is used to deliver the therapeutic compound to the vascular occlusion.

21. The method of claim 18, wherein the ultrasound radiating member is positioned upstream with respect to the vascular occlusion.

22. The method of claim 18, wherein the ultrasound radiating member is positioned within the vascular occlusion.

23. The method of claim 18, wherein the ultrasound radiating member is coupled to a guidewire used to deliver a catheter to the treatment site, wherein the catheter include a fluid delivery lumen hat is used to deliver the therapeutic compound to the treatment site.

24. The method of claim 18, further comprising evaluating a characteristic of the second ultrasonic energy field using the ultrasound radiating member.
